(19) United States
(12) Patent Application Publication
(10) Pub. No.: US 2026/0034779 A1
(43) Pub. Date: Feb. 5, 2026

(54) Method for Controlling Inkjet Recording Device

(71) Applicant: Hitachi Industrial Equipment Systems Co., Ltd., Tokyo (JP)

(72) Inventors: Takahiro ARIMA, Tokyo (JP); Sho MIZOGUCHI, Tokyo (JP); Akira MIYAO, Tokyo (JP); Fumiomi UEDA, Tokyo (JP); Mamoru OKANO, Tokyo (JP)

(21) Appl. No.: 19/355,674

(22) Filed: Oct. 10, 2025

Related U.S. Application Data
(62) Division of application No. 17/597,197.

(30) Foreign Application Priority Data
Jul. 10, 2019 (JP) 2019-128747

(51) Int. Cl. B41J 2/02; B41J 2/08; B41J 2/165; B41J 2/175; B41J 2/185

(52) U.S. Cl. CPC B41J 2/02; B41J 2/08; B41J 2/16508; B41J 2/16552; B41J 2/175; B41J 2/185; B41J 2002/022

(57) ABSTRACT

A method for controlling an inkjet recording device includes providing a print head and providing a main body. The method also includes controlling, when the print head is set in the head cleaning unit, the supply of the ink to the nozzle and the recovery of the discharged ink from the gutter, wherein the gutter is located between the nozzle and recovery container. The method also includes providing a plurality of ink circulation path. The method also includes connecting, a pump to the circulation paths, and circulating, using the pump, the ink in a state where the print head is set in the head cleaning unit.

### CROSS REFERENCE TO RELATED APPLICATIONS

This application is a divisional of application Ser. No. 17/597,197, filed Dec. 29, 2021, which is a U.S. National Stage of Application No. PCT/JP2020/019771, filed May 19, 2020, which claims priority to Japanese Patent Application No. 2019-128747, filed Jul. 10, 2019, the disclosures of all of which are expressly incorporated by reference herein.

### TECHNICAL FIELD

The present invention relates to an inkjet recording device that continuously sprays ink from a nozzle to perform printing on a medium to be printed, and to a method for controlling an inkjet recording device.

### BACKGROUND ART

A technique described in JP 2002-103636 A (Patent Document 1) has been known as a technique related to nozzle cleaning in the technical field. Patent Document 1 describes “In a print head, a cleaning jet that is fixed is installed on a downstream side of an ink nozzle to be cleaned in a state where the cleaning jet is shifted sideways from the nozzle. When inkjet is stopped, a predetermined amount of a solvent is sprayed by the cleaning jet, and hits the nozzle at a predetermined angle. In such a manner, a front surface of a droplet generator is cleaned, and ink residue is discharged toward a side opposite a housing. Next, compressed dry air is blown toward the ink nozzle through the cleaning jet to dry a front portion of the nozzle, and ink residue adheres to a side portion of the housing.”

In addition, a technique described in JP 2015-136934 A (Patent Document 2) has been known as another technique related to nozzle cleaning. Patent Document 2 describes “A cleaning nozzle, namely, an ASC nozzle is provided that cleans a nozzle of a head. The ASC nozzle is used to spray a cleaning liquid (solvent) from the ASC nozzle and to clean a nozzle discharge port. Specifically, the ASC nozzle (cleaning nozzle) is disposed to face the nozzle discharge port inside the head. The ASC nozzle (cleaning nozzle) communicates with a solvent line and a solvent tank via an air valve that is openable and closeable. When the nozzle is cleaned, the air valve that is an opening and closing valve is opened, and the solvent supplied from the solvent tank is sprayed from the ASC nozzle.”

### CITATION LIST

### Patent Document

Patent Document 1: JP 2002-103636 A
Patent Document 2: JP 2015-136934 A

### SUMMARY OF THE INVENTION

### Problems to be Solved by the Invention

In the technique of Patent Document 1, when the print head is cleaned, ink residue adhering to the nozzle inside the print head adheres to a portion that is different from the nozzle (side portion of the housing of the print head). For this reason, a separate worker needs to manually clean the portion with the solvent, and the work is troublesome. Further, Patent Document 1 does not describe how to treat the solvent after cleaning.

In addition, in the technique of Patent Document 2, the solvent (cleaning liquid) is sprayed from the cleaning nozzle (ASC nozzle) provided inside the print head, to clean the nozzle discharge port, and similarly to Patent Document 1, manual work is required to remove ink residue that adheres to the print head because of cleaning. In addition, Patent Document 2 also does not describe how to treat the solvent (cleaning liquid) after the cleaning of the print head.

Therefore, an object of the present invention is to provide an inkjet recording device and a method for controlling an inkjet recording device capable of cleaning a print head and easily recovering a solvent (cleaning liquid) that is used for cleaning of the print head.

### Solutions to Problems

In order to achieve the above object, according to one aspect of the present invention, there is provided an inkjet recording device including: a print head that receives a supply of ink to perform printing; and a main body that includes an ink container to contain the ink and a solvent container to contain a solvent, and that supplies the ink in the ink container to the print head. The print head includes a nozzle that discharges the ink as ink particles, a charging electrode that charges the ink particles discharged from the nozzle, according to a printing content, a deflection electrode that changes a flight direction of the charged ink particles, and a gutter that recovers the ink particles making no contribution to the printing. The inkjet recording device includes a head cleaning unit including a cleaning tank in which the print head is to be set, a cleaning nozzle that sprays the solvent toward the print head set inside the cleaning tank, to clean the print head, and a recovery container provided at a bottom portion of the cleaning tank to recover the solvent after cleaning; and a drive unit that supplies the solvent to the cleaning nozzle.

In addition, according to another aspect of the present invention, there is provided a method for controlling an inkjet recording device including a print head that receives a supply of ink to perform printing, and a main body that includes an ink container to contain the ink and a solvent container to contain a solvent, and that supplies the ink in the ink container to the print head, the method including: setting the print head inside a cleaning tank including a cleaning nozzle that sprays the solvent; and spraying the solvent from the cleaning nozzle after the setting to clean the print head, and recovering the solvent after the cleaning in a recovery container provided at a bottom portion of the cleaning tank.

### Effects of the Invention

According to the present invention, it is possible to provide the inkjet recording device and the method for controlling an inkjet recording device capable of easily cleaning the print head and easily recovering the solvent (cleaning liquid) that is used for cleaning of the print head.

### BRIEF DESCRIPTION OF THE DRAWINGS

FIG. 1 is a perspective view illustrating a usage situation of an inkjet recording device in a first embodiment of the present invention.

FIG. 2 is a perspective view illustrating a state where a print head is set in a cleaning unit in the first embodiment.

FIG. 3 is a perspective view illustrating a state where the head cleaning unit is fixed to a main body in the first embodiment.

FIG. 4 is a diagram illustrating a path configuration of the inkjet recording device in the first embodiment.

FIG. 5 is a diagram illustrating a path configuration of the inkjet recording device in a state where the head cleaning unit is removed in the first embodiment.

FIG. 6 is a diagram illustrating a path configuration of the head cleaning unit that is removed from the main body of the inkjet recording device in the first embodiment.

FIG. 7 is a fluid path diagram illustrating flows of liquids with thick lines when a head cleaning process is performed in the first embodiment.

FIG. 8 is a fluid path diagram illustrating flows of air with thick lines when a head drying process is performed in the first embodiment.

FIG. 9 is a fluid path diagram illustrating flows of ink and a solvent with thick lines when an ink and solvent replenishment operation is performed in the first embodiment.

FIG. 10 is a fluid path diagram illustrating flows of the ink with thick lines when an ink circulation process is performed in the first embodiment.

FIGS. 11A and 11B are configuration views of the print head in the first embodiment.

FIG. 12 is a configuration view of the head cleaning unit in the first embodiment.

FIG. 13 is a cross-sectional view of the head cleaning unit in a state where the print head is set in the head cleaning unit in the first embodiment.

FIG. 14 is an enlarged view of a periphery of the print head in FIG. 13.

FIG. 15 is a cross-sectional view of the head cleaning unit illustrating flows of liquid inside the head cleaning unit with thick lines when the head cleaning process is performed in the first embodiment.

FIGS. 16A-16C illustrate detection of a liquid level of a recovery container in each state in the first embodiment.

FIG. 17 is a cross-sectional view of the head cleaning unit when work of extracting liquid of the recovery container in the first embodiment.

FIGS. 18A and 18B are exterior perspective views of an inkjet recording device in a second embodiment of the present invention.

FIG. 19 is a perspective view illustrating a state where a print head is set in a cleaning unit in the inkjet recording device in the second embodiment.

FIG. 20 is a diagram illustrating a path configuration of the inkjet recording device in the second embodiment.

### MODE FOR CARRYING OUT THE INVENTION

Hereinbelow, specific embodiments of the present invention will be described with reference to the drawings. Incidentally, the present invention is not limited to embodiments to be described below. In addition, in the following drawings, the same numbers (reference signs) may be assigned to the same units, and a description of units that have been already described may be omitted.

### First Embodiment

### <Usage State>

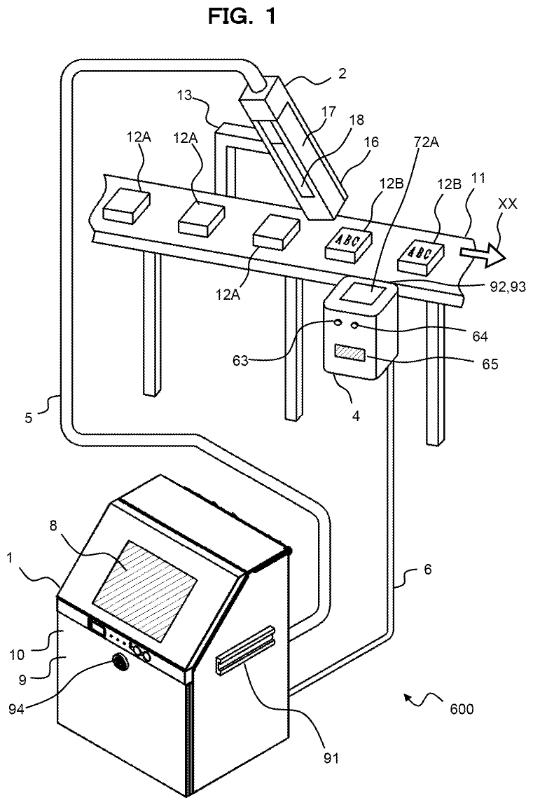

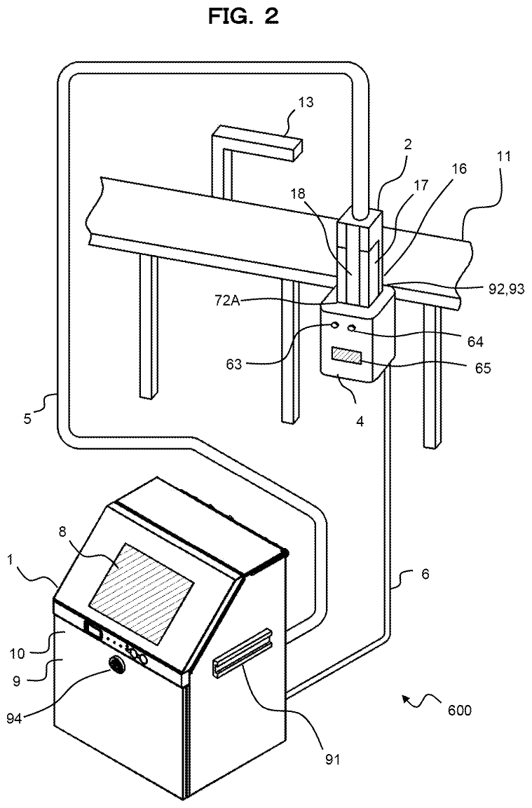

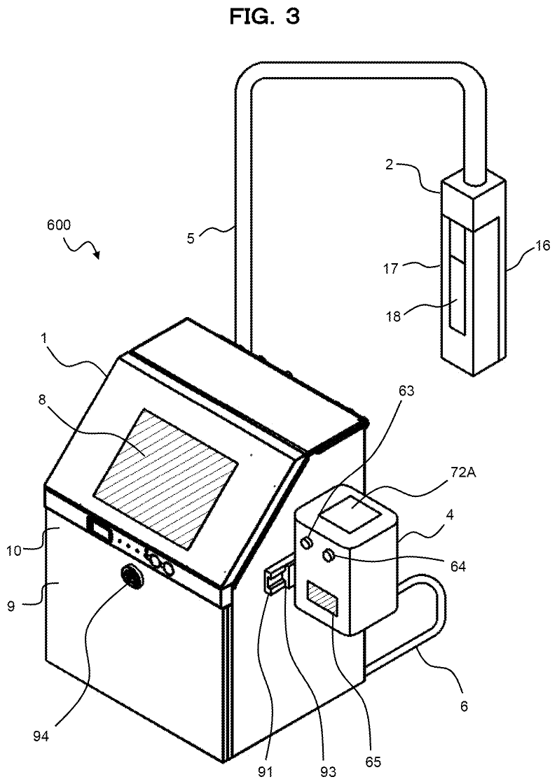

First, a usage state of an inkjet recording device 600 in a first embodiment of the present invention will be described with reference to FIGS. 1 to 3. FIG. 1 is a perspective view illustrating a usage state of the inkjet recording device 600 in the present embodiment. FIG. 2 is a perspective view illustrating a state where a print head 2 is attached to a head cleaning unit 4 in the inkjet recording device 600 according to the present embodiment. FIG. 3 is a perspective view illustrating a state where the head cleaning unit 4 is fixed to a main body 1 in the inkjet recording device 600.

First, as illustrated in FIG. 1, the inkjet recording device 600 according to the present embodiment includes the main body 1; the print head 2 that is connected to the main body 1 by a conduit 5 (for the print head); and the head cleaning unit 4 that is connected to the main body 1 by a conduit 6 for the head cleaning unit.

The inkjet recording device 600 is installed, for example, at a production line in a factory where food, beverages or the like are produced, and the main body 1 is installed in a place where a space required for regular maintenance work can be secured. The print head 2 is fixed to a print head fixing fitting 13 installed in the vicinity of a belt conveyor 11, and is installed in proximity to a production line such as the belt conveyor 11 to perform printing on objects 12A to 12B to be printed that are fed in a direction of an arrow XX on the production line. In addition, a protective cover 17 is attached to the print head 2 for the purpose of protecting components inside the print head 2.

In the inkjet recording device 600, a control unit 10 (specific configuration is not illustrated) provided inside the main body 1 controls a charge amount or a charging timing of ink particles 68B to be discharged from a nozzle 21 assembled to the print head 2. Namely, the control unit 10 performs control such that the ink particles 68B which are charged and deflected adhere to and are printed on the object 12B (during printing) to be printed while the object 12A (before printing) to be printed passes through the vicinity of the print head 2. In addition, the control unit 10 controls electromagnetic valves, pumps and the like provided inside the main body 1 to control the flow of ink and the flow of a solvent. Incidentally, the control unit 10 can use a computer. Specifically, the control unit 10 can be formed of a microprocessing unit (MPU); a memory that stores a program for operation of the MPU and data and information required for operation; and a print drive unit that operates the print head and configuration units inside the main body 1 according to an instruction of the MPU. Here, details of the control unit 10 will be omitted.

The head cleaning unit 4 is installed at the periphery of the print head 2. The head cleaning unit 4 in this embodiment is fixed by combining a fixing jig fitting portion 93 assembled to the head cleaning unit 4 with a fixing jig A 92 (for the conveyor) assembled to the belt conveyor 11. Then, the head cleaning unit 4 includes a print head insertion portion 72A that is an opening through which the print head 2 is inserted into the head cleaning unit 4.

Further, the head cleaning unit 4 includes a start button 63 that starts a cleaning process of the print head 2; a stop button 64 that stops the cleaning process of the print head 2; and a display portion 65 that allows a worker to recognize an alarm such as a confirmation message, warning, or abnormality.

The main body 1 includes a fixing jig 91 (for the main body) that fixes the head cleaning unit 4, and the head cleaning unit 4 can also be removed from the fixing jig 92 (for the conveyor) for fixing the head cleaning unit 4, attached to the fixing jig 91 (for the main body), and then used. In the present embodiment, the head cleaning unit 4 is fixed to the belt conveyor 11; however, in the inkjet recording device 600 of the present embodiment, the head cleaning unit 4 can be freely attached to a place where it is easy for a user to operate the head cleaning unit 4.

Next, a state where the print head 2 is set in the head cleaning unit 4 in the inkjet recording device 600 will be described with reference to FIG. 2. The print head 2 is inserted into the print head insertion portion 72A of the head cleaning unit 4 from a tip of the print head 2 and is set therein. In the inkjet recording device 600 according to the present embodiment, when the print head 2 is set in the head cleaning unit 4 in such a manner, the print head 2 can be cleaned with the solvent (cleaning liquid) to be supplied from a main body 1 side via the conduit 6.

Incidentally, a length of the conduit 6 (for the head cleaning unit) that connects the main body 1 and the head cleaning unit 4 is the same as a length of the conduit 5 (for the print head) that connects the main body 1 of the inkjet recording device and the print head 2, but it is preferable that the length of the conduit 6 is set to be longer therethan. This is to secure the degree of freedom in the disposition of the head cleaning unit 4.

Next, a state where the head cleaning unit 4 is fixed to the main body 1 in the inkjet recording device 600 will be described with reference to FIG. 3. The head cleaning unit 4 can be fixed to the main body 1 by combining the fixing jig fitting portion 93 with the fixing jig 91 assembled to the main body 1. Since the head cleaning unit 4 can be fixed to the main body 1, even when the belt conveyor 11 or the like has no space where the head cleaning unit 4 is attached, the head cleaning unit 4 can be installed.

### <Path Configuration>

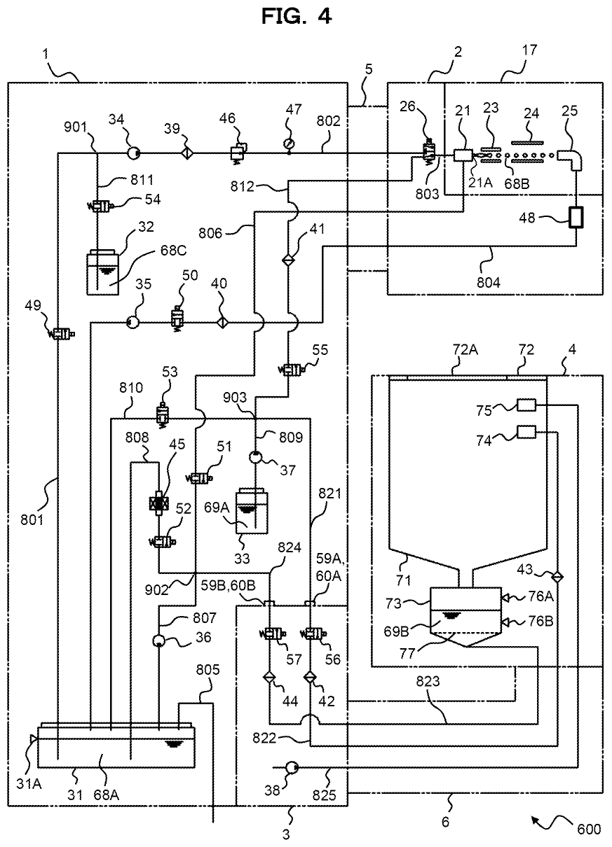

Next, a path configuration of the inkjet recording device 600 in the present embodiment will be described with reference to FIG. 4. FIG. 4 is a diagram illustrating an overall path configuration of the inkjet recording device 600 in the present embodiment.

First, ink supply paths (paths 801 to 803) of the inkjet recording device 600 in the present embodiment will be described. In FIG. 4, the main body 1 is provided with an ink container 31 that retains circulating ink 68A. The ink container 31 is provided with a liquid level sensor 31A that detects whether or not the ink in the ink container 31 reaches a reference liquid level that is an amount appropriate for being retained thereinside.

The ink container 31 is connected to the path 801 (for supply) at a portion that is immersed in the ink 68A, and an electromagnetic valve 49 (for supply) that opens and closes a path is installed in the middle of the path 801. Further, the path 801 is connected to a pump 34 (for supply) that is installed in the path 802 and that is used to suction and pressure-feed the ink 68A, via a merging path 901. Then, the path 801 is connected to a filter 39 (for supply) that removes foreign matter mixed in the ink 68A, on an output side of the pump 34 (for supply).

The filter 39 (for supply) is connected to a pressure regulating valve 46 that regulates the pressure of the ink 68A which is pressure-fed from the pump 34 (for supply), at a pressure appropriate for printing, and the pressure regulating valve 46 is connected to a pressure sensor 47 that measures a pressure of the ink 68A to be supplied to the nozzle 21. The path 802 in which the pressure sensor 47 is disposed passes through the conduit 5 (for the print head), and is connected to a switching valve 26 that is provided inside the print head 2 to control whether or not to supply the ink 68A to the nozzle 21.

The switching valve 26 is connected to the nozzle 21 including a discharge port 21A that discharges the ink 68A, via the path 803. Incidentally, the switching valve 26 is a three-way electromagnetic valve. The path 802 for ink supply and a path 812 for nozzle cleaning are connected to the switching valve 26, and the switching valve 26 is capable of switching between the supply of the ink 68A to and the supply of solvent 69A to the nozzle 21. A charging electrode 23 that imparts a predetermined charge amount to the ink particles 68B, a deflection electrode 24 that deflects the ink particles 68B to be used for printing, and a gutter 25 that captures the ink particles 68B which are not charged because of not being used for printing and which fly straight through the deflection electrode are disposed in a straight direction of the discharge port 21A of the nozzle 21.

Next, an ink recovery path 804 of the inkjet recording device 600 in the present embodiment will be described. In FIG. 4, the gutter 25 is connected to the path 804, and a charge sensor 48 that detects whether or not the ink particles 68B to which the charge amount is imparted by the charging electrode 23 are recovered is disposed in the path 804. Then, the path 804 passes through the conduit 5 (for the print head), and is connected to a filter 40 (for recovery) that is disposed inside the main body 1 to remove foreign matter mixed in the ink, and the filter 40 (for recovery) is connected to an electromagnetic valve 50 (for recovery) that opens and closes a path.

The electromagnetic valve 50 (for recovery) is connected to a pump 35 (for recovery) that suctions the ink particles 68B captured by the gutter 25, and the pump 35 (for recovery) is connected to the ink container 31 via a path. The electromagnetic valve 50 is opened and the pump 35 is driven to recover the ink particles 68B captured by the gutter 25, in the ink container 31. In addition, the ink container 31 has a configuration in which the ink container 31 is connected to a path 805 in an upper space that is not in contact with the ink 68A and the path 805 communicates with the outside of the main body 1.

Next, circulation paths (paths 806 and 807) of the inkjet recording device 600 in the present embodiment will be described. In addition to the path 803 for ink supply, the path 806 passing through the conduit 5 (for the print head) is connected to the nozzle 21 provided inside the print head 2. An electromagnetic valve 51 (for circulation) that is provided inside the main body 1 to open and close a flow path is disposed in the path 806.

The electromagnetic valve 51 (for circulation) is connected to the path 807 via a merging path 902, and a pump 36 (for circulation) that suctions the ink from the nozzle 21 is disposed in the path 807. Then, the pump 36 (for circulation) is configured to be connected to the ink container 31.

Next, viscosity measurement paths (paths 808 and 807) of the inkjet recording device 600 in the present embodiment will be described. In FIG. 4, the ink container 31 is connected to the path 808 at a portion that is not immersed in the ink 68A. The path 808 is connected to a viscometer 45 that measures a viscosity of the ink 68A in the ink container 31, via the path 801. The viscometer 45 is connected to an electromagnetic valve 52 (for viscosity measurement) that opens and closes a path. The electromagnetic valve 52 (for viscosity measurement) is configured to be connected to the pump 36 (for circulation) disposed in the path 807, via the merging path 902. Accordingly, the ink 68A in the ink container 31 can be circulated through the viscosity measurement paths and the viscosity of the ink 68A can be measured. The viscosity measured in such a manner is input to the control unit 10 in the drawing, and is used for control of the viscosity of the ink 68A in the ink container 31.

Next, solvent replenishment paths (paths 809 and 810) of the inkjet recording device 600 in the present embodiment will be described. In FIG. 4, the main body 1 is provided with a solvent container 33 that retains the solvent 69A to be used for the replenishment of the solvent to the ink container 31, nozzle cleaning, or head cleaning. The solvent container 33 is connected to the path 809 at a portion that is immersed in the solvent 69A, and a pump 37 (for the solvent) that is used to suction and pressure-feed the solvent is disposed in the path 809. Then, the pump 37 (for the solvent) is connected to a branch path 903 that changes a supply destination of the solvent 69A according to the purpose. The branch path 903 is connected to an electromagnetic valve 53 (for solvent replenishment) that is disposed in the path 810 of the solvent replenishment paths to open and close a flow path, and the electromagnetic valve 53 (for solvent replenishment) is configured to be connected to the ink container 31.

Next, an ink replenishment path 811 of the inkjet recording device 600 in the present embodiment will be described. In FIG. 4, the main body 1 is provided with an auxiliary ink container 32 that retains ink 68C for replenishment. The auxiliary ink container 32 is connected to the path 811 at a portion that is immersed in the ink 68C. The path 811 is connected to an electromagnetic valve 54 (for ink replenishment) that opens and closes a path, and the electromagnetic valve 54 (for ink replenishment) is connected to the pump 34 (for supply) that is installed in the path 802 and that is used to suction and pressure-feed the ink 68C, via the merging path 901. Then, the ink 68C in the auxiliary ink container 32 is replenished to the ink container 31 via the nozzle 21 and via the gutter 25, the path 804, the electromagnetic valve 50, and the pump 35.

Next, nozzle cleaning paths (paths 809 and 812) of the inkjet recording device 600 in the present embodiment will be described. In FIG. 4, the pump 37 (for the solvent) disposed in the path 809 is connected to the path 812 via the branch path 903. The path 812 is connected to an electromagnetic valve 55 (for nozzle cleaning) that opens and closes a flow path. Then, the electromagnetic valve 55 (for nozzle cleaning) is connected to a filter 41 (for nozzle cleaning) that removes foreign matter mixed in the solvent 69A. The filter 41 (for nozzle cleaning) is configured to be connected to the switching valve 26 that is provided inside the print head 2 via the path 812 passing through the conduit 5 (for the print head) to control whether or not to feed the solvent 69A for cleaning to the nozzle 21.

Next, head cleaning paths (paths 809, 821 and 822) of the inkjet recording device 600 in the present embodiment will be described. In FIG. 4, the pump (for the solvent) is connected to the path 821 via the branch path 903, and the path 821 is connected to the path 822 via a connecting portion 59A (for head cleaning) and a joint 60A (for head cleaning) for relaying to a drive unit 3 assembled into the main body 1. An electromagnetic valve 56 (for nozzle cleaning) that opens and closes a flow path is disposed in the path 822, and the electromagnetic valve 56 (for nozzle cleaning) is connected to a filter 42 (for head cleaning) that removes foreign matter mixed in the solvent 69A.

The filter 42 (for head cleaning) is connected to a filter 43 (for nozzle cleaning) that is provided inside the head cleaning unit 4 via the path 822 passing through the conduit 6 (for the head cleaning unit) to remove foreign matter which has initially entered the path 822. Then, an output side of the filter 43 (for nozzle cleaning) is connected to a cleaning nozzle 74 provided inside a cleaning tank 71 of the head cleaning unit 4. Here, an internal space of the cleaning tank 71 is configured to communicate with a recovery container 73 installed at a lower portion of the cleaning tank 71.

Next, solvent reuse paths (paths 823, 824 and 807) of the inkjet recording device 600 in the present embodiment will be described. In FIG. 4, the head cleaning unit 4 is provided with the recovery container 73 that contains a recovery solvent 69B which is used for head cleaning and then flows thereinto because of its own weight. A filter 77 (for the recovery container) is assembled to the recovery container 73 such that foreign matter which is mixed during head cleaning is prevented from flowing into the path 823. The recovery container 73 is connected to the path 823 at a portion that is immersed in the recovery solvent 69B. The path 823 passes through the conduit 6 (for the head cleaning unit), and is connected to a filter 44 (for solvent reuse) inside the drive unit 3 assembled into the main body 1. The filter 44 is intended to prevent fine foreign matter contained in the recovery solvent 69B, from being mixed into the ink 68A. Further, an output side of the filter 44 (for solvent reuse) is connected to an electromagnetic valve 57 (for solvent reuse) that opens and closes a flow path from the path 823. The path 823 in which the electromagnetic valve 57 (for solvent reuse) is disposed is connected to the path 824 via a connecting portion 59B (for solvent reuse) and a connecting portion 60B (for solvent reuse) for relaying between the main body 1 and the drive unit 3. The path 824 is configured to be connected to the pump 36 (for circulation) disposed in the path 807, via the merging path 902. Accordingly, the recovery solvent 69B retained in the recovery container 73 can be replenished to the ink container 31 inside the main body 1 via the drive unit 3. The concentration (viscosity) of the ink can be adjusted by the replenishment, and the ink can be reused for viscosity adjustment. Namely, when the viscosity detected by the viscometer 45 is a predetermined value or more, the control unit 10 causes the solvent 69B in the recovery container 73 that is used for cleaning, to be supplied to the ink container 31 via the path 823, the filter 44, the electromagnetic valve 57, the connecting portion 60B, the path 824, the branch 902, the path 807, and the pump 36.

Next, a head drying air path 825 of the inkjet recording device 600 in the present embodiment will be described. In FIG. 4, the drive unit 3 stored inside the main body 1 is provided with a pump 38 (for dry air supply) that is used to suction and pressure-feed air, and the pump 38 (for dry air supply) forms an air suction port communicating with the inside of the main body 1. The pump 38 (for dry air supply) is connected to an air nozzle 75 that is provided inside the cleaning tank 71 of the head cleaning unit 4 via the path 825 passing through the conduit 6 (for the head cleaning unit).

### <Head Cleaning Unit Assembly Structure>

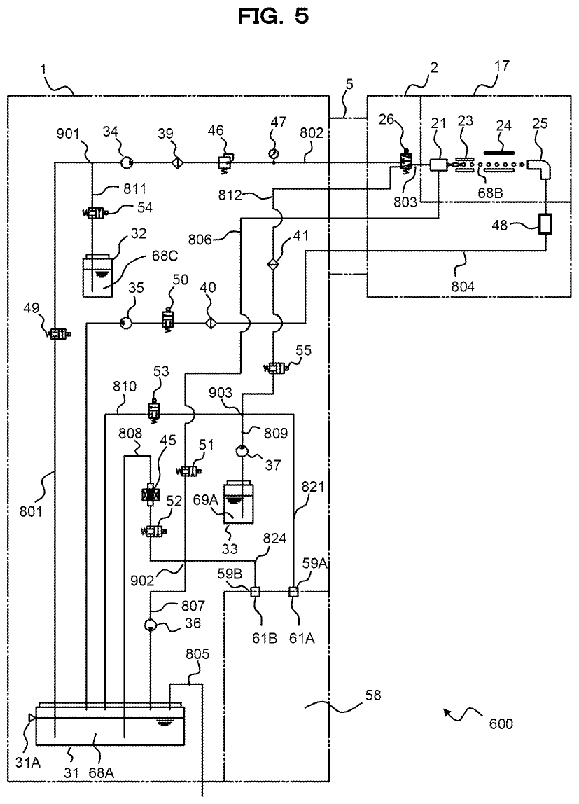

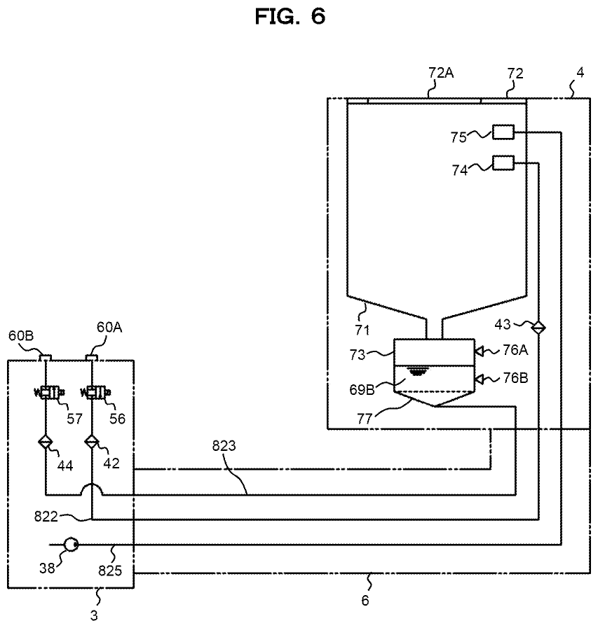

Next, a configuration of assembling the head cleaning unit 4 into the inkjet recording device 600 in the present embodiment will be described with reference to FIGS. 4 to 6. FIG. 4 is a path configuration diagram illustrating a state where the head cleaning unit 4 is assembled into the inkjet recording device 600 in the present embodiment. FIG. 5 is a path configuration diagram illustrating a state where the head cleaning unit 4 is not assembled into the inkjet recording device 600 in the present embodiment. Then, FIG. 6 is a path configuration diagram of the head cleaning unit 4 and the drive unit 3.

In FIG. 5, the head cleaning unit 4 and the drive unit 3 are removed from the main body 1 of the inkjet recording device 600. A seal plug 61A is attached to the connecting portion 59A (for head cleaning) in the path 821 to be connected to the cleaning nozzle 74 of the head cleaning unit 4, to block a flow path. In addition, a seal plug 61B is attached to the connecting portion 59B (for solvent reuse) in the path 824 to be connected to the recovery container 73 of the head cleaning unit 4, to block a flow path. In addition, the main body 1 secures a storage area 58 where the drive unit 3 is disposed.

Next, FIG. 6 illustrates a state where the head cleaning unit 4 is removed from the main body 1 of the inkjet recording device 600. The head cleaning unit 4 is connected to the drive unit 3 by the conduit 6 (for the head cleaning unit). The drive unit 3 is configured such that the pump 38 (for dry air supply), the electromagnetic valve 56 (for head cleaning), the electromagnetic valve 57 (for solvent reuse), the filter 42 (for head cleaning), and the filter 44 (for solvent reuse) are assembled into each other.

As described above, in the inkjet recording device 600 according to the present embodiment, the main body 1 and the head cleaning unit 4 can be separated from each other. Accordingly, the head cleaning unit 4, the drive unit 3, and the conduit 6 that connects the drive units 3 and 4 can be easily carried as one head cleaning device. When the print head 2 is cleaned, the head cleaning device is attached to the main body 1 for use.

### <Operation and Flow of Liquid>

Next, a driving operation of the inkjet recording device 600 in the present embodiment will be described.

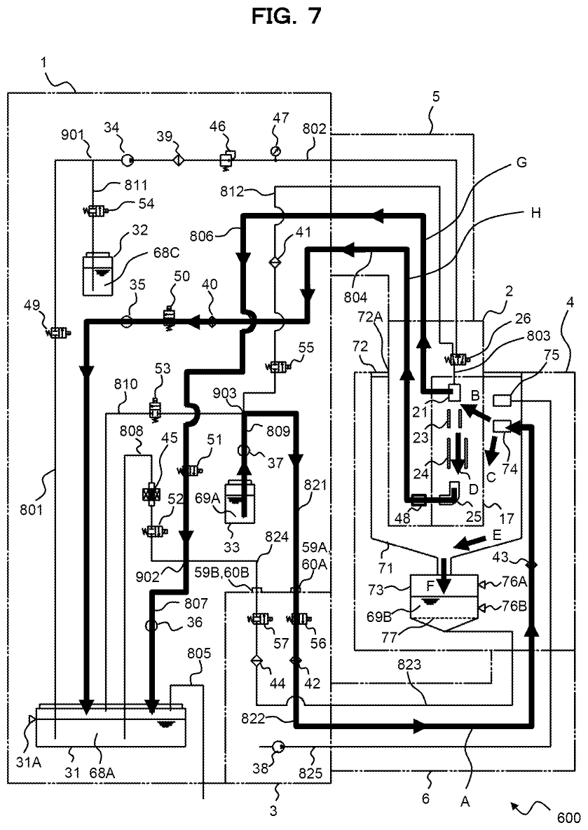

FIG. 7 is a fluid path diagram illustrating a flow of the solvent and a flow of air with thick lines when a head cleaning process is performed in the inkjet recording device 600 according to the first embodiment.

In FIG. 7, the inkjet recording device 600 is in a state where the print head 2 is set (inserted) in the head cleaning unit 4 for cleaning. In the head cleaning paths (paths 809, 821 and 822), the electromagnetic valve 56 (for head cleaning) is energized to open the flow path and the pump 37 (for the solvent) is operated, so that the solvent can be supplied to the head cleaning unit 4 as indicated by a thick arrow line A. Namely, the solvent 69A contained in the solvent container 33 of the main body 1 can be supplied to the cleaning nozzle 74 assembled into the cleaning tank 71 of the head cleaning unit 4.

The cleaning nozzle 74 sprays the solvent 69A toward the print head to clean the print head. Specifically, a part of the solvent 69A supplied to the cleaning nozzle 74 is discharged toward the nozzle 21 and the like surrounded by the protective cover 17 of the print head 2 as indicated by a thick arrow line B, and the other part of the solvent 69A is discharged toward the protective cover 17 on an outer side of the print head 2 as indicated by a thick arrow line C. The solvent 69A discharged from the cleaning nozzle 74 as indicated by the thick arrow line B cleans components such as the nozzle 21, the charging electrode 23, the deflection electrode 24, and the gutter 25 that are assembled inside the print head 2 as indicated by a thick arrow line D, and additionally drips downward because of its own weight as indicated by a thick arrow line E. The solvent 69A that has dripped to the lower portion of the cleaning tank 71 flows toward the recovery container 73 as indicated by a thick arrow line F, and is contained in the recovery container 73 as the recovery solvent 69B.

In the ink circulation paths (paths 806 and 807), the electromagnetic valve 51 (for circulation) is energized to open the flow path and the pump 36 (for circulation) is operated, so that a part of the solvent 69A that has hit the nozzle 21 is suctioned from the nozzle 21A and is recovered in the ink container 31 of the main body 1 as indicated by a thick arrow line G. In such a head cleaning process, the inside of the nozzle 21 and of the ink circulation paths 806 and 807 can also be cleaned with the solvent 69A.

Furthermore, in the ink recovery path 804, the electromagnetic valve 50 (for recovery) is energized to open the flow path and the pump 35 (for recovery) is operated, so that a part of the solvent 69A that has hit the gutter 25 is suctioned from the gutter 25 and is recovered in the ink container 31 of the main body 1 as indicated by a thick arrow line H. In such a head cleaning process, the inside of the gutter 25 and of the ink recovery path 804 can also be cleaned with the solvent 69A.

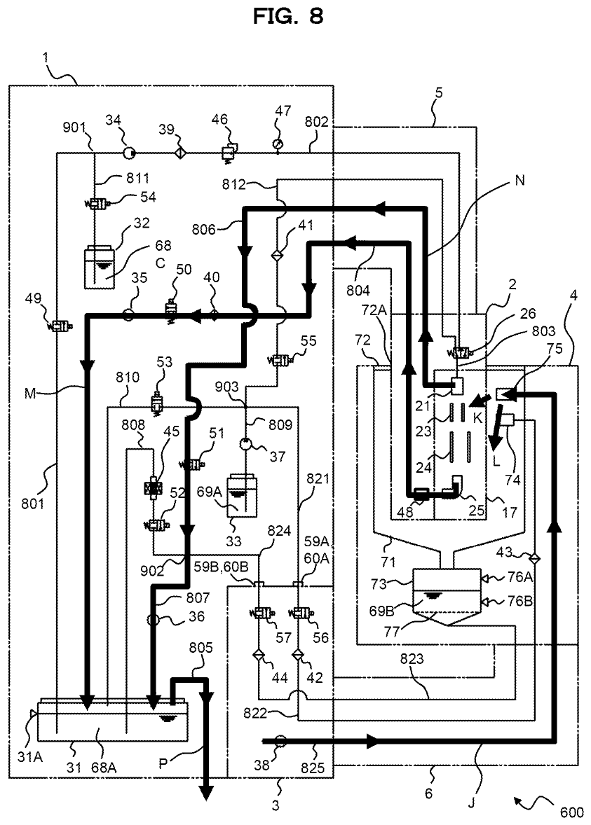

Next, FIG. 8 is a fluid path diagram illustrating a flow of air with thick lines when a head drying process is performed in the inkjet recording device 600 according to the present embodiment. In FIG. 8, the inkjet recording device 600 is in a state where the print head 2 is set in the head cleaning unit 4, and carries out the head drying process after the head cleaning process is completed. In the head cleaning path 825, the pump 38 (for dry air supply) installed in the main body 1 is operated, so that compressed air is supplied to the air nozzle 75 assembled into the cleaning tank 71 of the head cleaning unit 4 as indicated by a thick arrow line J.

A part of the air supplied to the air nozzle 75 is discharged toward the charging electrode 23 and the like surrounded by the protective cover 17 of the print head 2 as indicated by a thick arrow line K, and the other part of the air is discharged toward the protective cover 17 on the outer side of the print head 2 as indicated by a thick arrow line L. The air discharged from the air nozzle 75 as indicated by the thick arrow line K dries components such as the nozzle 21, the charging electrode 23, the deflection electrode 24, and the gutter 25 that are assembled inside the print head 2.

In the ink recovery path 804, the electromagnetic valve 50 (for recovery) is energized to open the flow path and the pump 35 (for recovery) is operated, so that a part of the air is suctioned from the gutter 25 and is suctioned and pressure-fed to the ink container 31 of the main body 1 as indicated by a thick arrow line M. In addition, in the ink circulation paths (paths 806 and 807), the electromagnetic valve 51 (for circulation) is energized to open the flow path and the pump 36 (for circulation) is operated, so that a part of the air is suctioned from the nozzle 21 and is suctioned and pressure-fed to the ink container 31 of the main body 1 as indicated by a thick arrow line N. Then, the air that has flowed into the ink container 31 is discharged from the exhaust path 805 to the outside of the main body 1 as indicated by a thick arrow line P. In such a manner, during the head drying process, the air can be suctioned from the gutter 25 and the nozzle 21 to reduce the amount of solvent gas to be discharged to a periphery of the head cleaning unit 4. When the flow rate of the air that is supplied from the air nozzle 75 into the cleaning tank 71 is larger than the flow rate of the air that is suctioned from the inside of the cleaning tank 71 by the gutter 25 and the nozzle 21, the diffusion of solvent gas to the periphery of the head cleaning unit 4 can be reduced as much as possible.

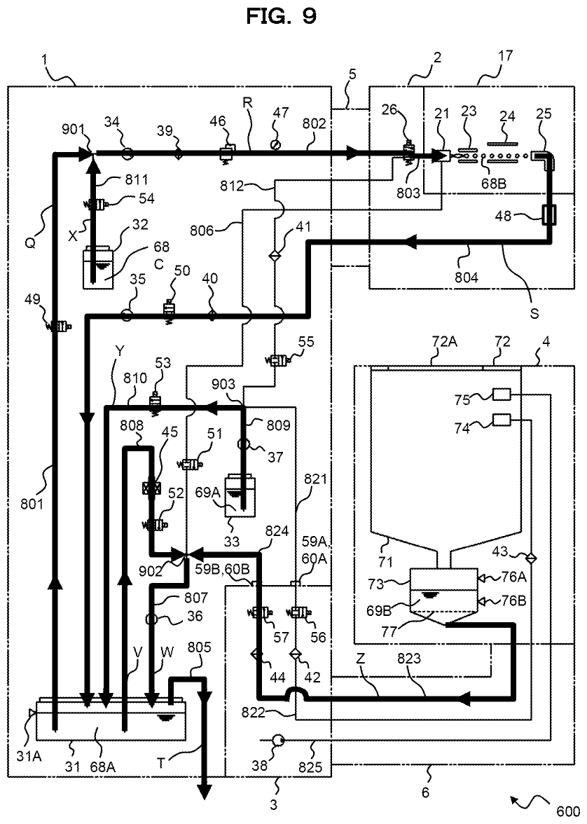

Next, FIG. 9 is a fluid path diagram illustrating flows of the ink, the solvent, and air with thick lines when circulation control of the ink 68A, replenishment control of the ink 68C, and replenishment control of the solvents 69A and driving are performed in the inkjet recording 69B during device 600 according to the present embodiment. FIG. 9 illustrates that the inkjet recording device 600 is in a state where the print head 2 is removed from the head cleaning unit 4 and printing can be performed. In the ink supply paths 801 to 803, the electromagnetic valve 49 (for supply) is energized to open the flow path and the pump 34 (for supply) is operated, so that the ink 68A contained in the ink container 31 of the main body 1 is supplied to the nozzle 21 of the print head 2 and is discharged from the nozzle 21 as the ink particles 68B as indicated by thick arrow lines Q and R.

In the ink recovery path 804, the electromagnetic valve 50 (for recovery) is energized to open the flow path and the pump 35 (for recovery) is operated, so that the ink particles 68B and air around the print head 2 are suctioned from the gutter 25 and are suctioned and pressure-fed to the ink container 31 of the main body 1 as indicated by a thick arrow line S. In the ink recovery path 804, since the ink 68A and the air flow in a gas-liquid mixed state, a solvent component of the ink 68A dissolves in the air, and the air becomes solvent gas and flows into the ink container 31. The ink 68B that has flowed into the ink container 31 is contained in a bottom portion, and the air that has become solvent gas is discharged to the outside of the main body 1 as solvent gas as indicated by an arrow T.

In the inkjet recording device 600, since the solvent component in the ink 68A is discharged to the outside of the device as solvent gas in such a manner, when the driving time is increased, the ratio of the solvent component in the ink 68A decreases, and the concentration of the ink 68A becomes high. For this reason, in the viscosity measurement paths 808 and 807, the electromagnetic valve 52 (for viscosity measurement) is energized to open the flow path and the pump 36 (for circulation) is operated, so that the ink 68A in the ink container 31 is fed to the viscometer 45 and the concentration of the ink 68A is regularly measured as indicated by arrows V and W. The measured viscosity is input to the control unit 10. As a result, the control unit 10 performs control such that when the concentration of the ink 68A is low, the ink 68C in the auxiliary ink container 32 is replenished to the ink container 31, and such that when the concentration of the ink 68A is high, the recovery solvent 69B in the recovery container 73 is replenished to the ink container 31 or the solvent 69 in the solvent container 33 is replenished to the ink container 31.

In the ink replenishment paths (paths 811 and 802), in a state where the electromagnetic valve 54 (for ink replenishment) is energized to open the flow path and the electromagnetic valve 49 (for supply) is not energized to close the flow path, the pump 34 (for supply) is operated, so that the ink 68C of the auxiliary ink container 32 is supplied to the nozzle 21 and is discharged from the nozzle 21 as the ink particles 68B. Then, the ink 68C is replenished to the ink container 31 via the ink recovery path 804.

In the solvent reuse paths (823, 824 and 807), when the concentration of the ink 68A is high, the electromagnetic valve 57 (for solvent reuse) is energized to open the flow path and the pump 36 (for circulation) is operated, so that the recovery solvent 69B contained in the recovery container 73 of the head cleaning unit 4 is replenished to the ink container 31 of the main body 1. Then, in the solvent replenishment paths 809 and 810, when the concentration of the ink 68A is high and the liquid level of the recovery container 73 is detected as being equal to or less than a minimum liquid amount detection portion 76B of a liquid amount sensor 76, the electromagnetic valve 53 (for solvent replenishment) is energized to open the flow path and the pump 37 (for the solvent) is operated, so that the solvent 69A contained in the solvent container 33 is replenished to the ink container 31.

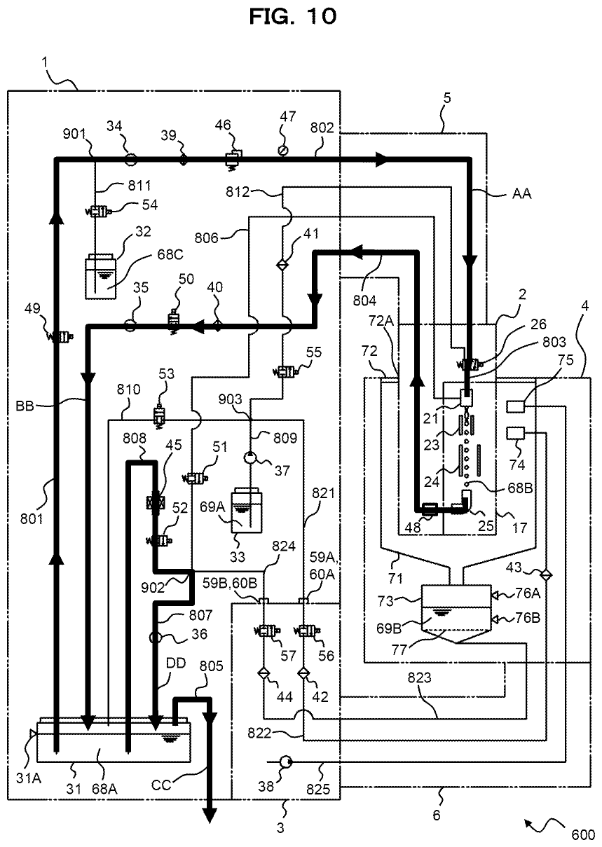

Next, FIG. 10 is a fluid path diagram illustrating flows of the ink with thick lines when the inkjet recording device 600 in the present embodiment is in a state where the print head 2 is set in the head cleaning unit 4 and when an ink circulation process is performed. Even when the inkjet recording device 600 is not used for a period of approximately 1 to 2 weeks, ink circulation is regularly (approximately once every 2 to 3 days) carried out, so that trouble can be reduced when driving is started for use next time. For this reason, in FIG. 10, control when the ink 68A is wanted to be automatically and regularly circulated will be described.

In the ink supply paths (paths 801 to 803), the electromagnetic valve 49 (for supply) is energized to open the flow path and the pump 34 (for supply) is operated, so that the ink 68A contained in the ink container 31 of the main body 1 is supplied to the nozzle 21 of the print head 2 and is discharged from the nozzle 21 as the ink particles 68B as indicated by a thick arrow line AA.

In the ink recovery path 804, the electromagnetic valve 50 (for recovery) is energized to open the flow path and the pump 35 (for recovery) is operated, so that the ink particles 68B and air around the print head 2 are suctioned from the gutter 25 and are suctioned and pressure-fed to the ink container 31 of the main body 1 as indicated by a thick arrow line BB. Then, the ink 68B that has flowed into the ink container 31 is contained in the bottom portion, and the air that has become solvent gas is discharged to the outside of the main body 1 as solvent gas as indicated by the arrow T. Then, as indicated by an arrow DD, control is performed such that the concentration of the ink 68A is regularly measured by the viscometer 45 and the concentration (viscosity) of the ink 68A is within a certain range.

In the case of performing ink circulation of the present embodiment, even when the ink particles 68B discharged from the nozzle 21 have not entered the gutter 25 because of trouble, the incident can be detected by the charge sensor 48. Furthermore, the ink 68B that is removed from the gutter 25 can be prevented from contaminating surroundings of the inkjet recording device 600. Even when the charge sensor 48 undergoes a failure or the like and is not capable of accurately detecting that the ink particles 68B have not entered the gutter 25, the overflow of the ink 68B can be detected by a maximum liquid amount detection portion 76A of the liquid amount sensor 76 provided in the recovery container 73, and the supply of the ink 68A to the nozzle 21 can be stopped.

Furthermore, in the inkjet recording device 600, head cleaning control can also be automatically and regularly carried out together with automatic and regular circulation control of the ink 68A. Hence, trouble can be further prevented at next use.

### <Structure of Print Head>

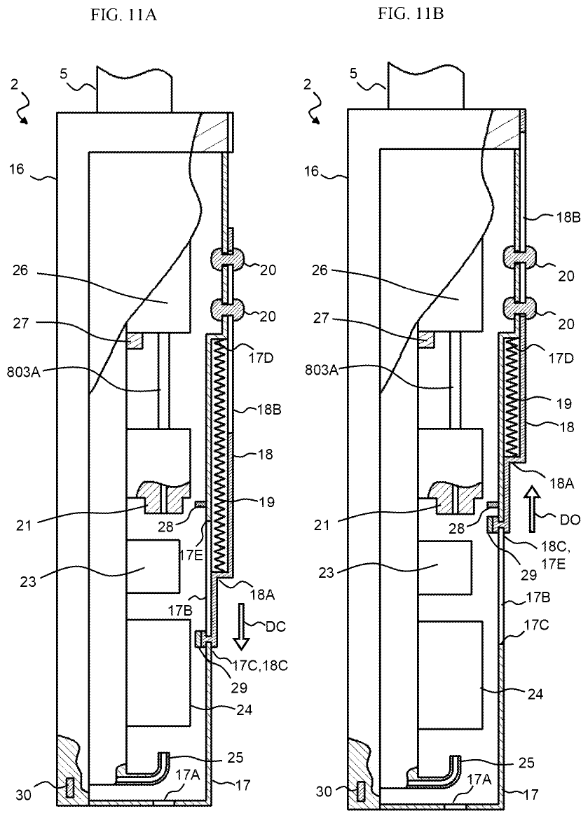

Next, a specific configuration of the print head 2 of the inkjet recording device 600 according to the first embodiment will be described with reference to FIG. 11. FIG. 11 is a partial cross-sectional view illustrating a configuration of the print head in the present embodiment. FIG. 11(a) illustrates a state where a protective cover door 18 of the print head 2 is closed. FIG. 11(b) illustrates a state where the protective cover door 18 of the print head 2 is opened.

In FIG. 11(a), the print head 2 includes a head base 16; the conduit 5 (for the print head) that connects the main body 1 and the print head 2; and the protective cover 17 that forms a printing opening portion 17A through which the ink particles 68B to be used for printing pass and that is assembled to the head base 16. The switching valve 26, the nozzle 21 connected to the switching valve 26 via a tube 803A, the charging electrode 23, the deflection electrode 24, and the gutter 25 are assembled to the head base 16. In addition, a temperature sensor A 27 that detects and uses ambient temperature for various controls is assembled to the print head 2. When the protective cover 17 is assembled, a space surrounded by the head base 16 and the protective cover 17 is protected from an impact or the like during maintenance.

Then, a cleaning opening portion 17B is formed in the protective cover 17, and the cleaning opening portion 17B can be opened and closed by the protective cover door 18 assembled to the protective cover 17. The assembly position of the protective cover door 18 is determined by a pin 20 fixed to the protective cover 17, and the protective cover door 18 slides in a direction of an arrow DC or in a direction opposite (arrow DO) the arrow DC within the range of a slot portion 18B formed in the protective cover door 18.

The protective cover 17 forms a seat surface portion 17D, and a door closing spring 19 is assembled to the seat surface portion 17D in a state where a load is applied to the protective cover door 18 in the direction of the arrow DC. The door closing spring pushes a back surface of an opening and closing support portion 18A formed in the protective cover door 18, in the direction of the arrow DC, so that the protective cover door 18 covers the cleaning opening portion 17B. At this time, the protective cover door 18 stands still at a position where an opening lower end portion 17C formed in the protective cover 17 and a door lower end portion 18C formed in the protective cover door 18 hit each other.

A magnet A 29 is assembled to the door lower end portion 18C, and a proximity sensor A 28 that detects when the magnet A 29 approaches the proximity sensor A 28 by a certain distance or less is assembled to the protective cover door 18. Then, when the protective cover door 18 covers the cleaning opening portion 17B, the magnet A 29 is separated, so that the proximity sensor A 28 is in a non-detectable state. For this reason, it can be determined that the protective cover 17 covers the cleaning opening portion 17B to protect the nozzle 21, the charging electrode 23, and the deflection electrode 24.

Next, in FIG. 11(b), a state where the protective cover door 18 of the print head 2 is opened will be described. The opening and closing support portion 18A of the protective cover door 18 is pushed in the direction of the arrow DO, and the door closing spring 19 is compressed. Then, the protective cover door 18 stands still at a position where the door lower end portion 18C of the protective cover door 18 and an opening upper end portion 17E of the protective cover 17 come into contact with each other. The proximity sensor A 28 assembled to the protective cover 17 is capable of detecting that a distance between the proximity sensor A 28 and the magnet A 29 assembled to the protective cover door 18 is the certain distance or less.

Incidentally, in FIG. 11, the protective cover door 18 adopts a slide type in which the protective cover door 18 is automatically opened when the print head 2 is inserted into the cleaning tank 71; however, the present invention is not limited thereto. Namely, the door may have any configuration as long as the door can be opened during cleaning in order to facilitate cleaning of the components (the nozzle 21, the charging electrode 23, the deflection electrode 24, the gutter 25 and the like) inside the print head. For example, a door that can be opened and closed upward and downward or rightward and leftward may be formed in the protective cover. In addition, the protective cover itself may be openable and closeable.

### <Structure of Head Cleaning Unit Assembly>

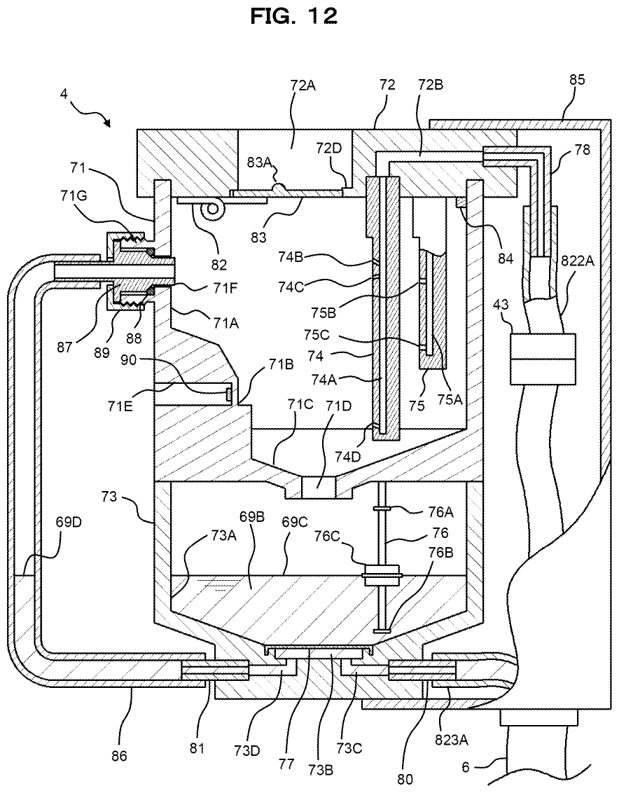

Next, a configuration of the head cleaning unit 4 of the inkjet recording device 600 according to the first embodiment will be described with reference to FIG. 12. FIG. 12 is a configuration view of the head cleaning unit 4 in the first embodiment (cross-sectional view of the cleaning nozzle 74).

In FIG. 12, the head cleaning unit 4 includes the cleaning tank 71 that contains the print head 2 during head cleaning; a lid block 72 which is installed at an upper portion of the cleaning tank 71 and in which the print head insertion portion 72A through which the print head 2 is set in the head cleaning unit 4 is formed; and the recovery container 73 that stores the recovery solvent 69B used for the head cleaning process.

A lid member 83 is assembled to the lid block 72 to prevent foreign matter such as dust from entering the cleaning tank 71 from the print head insertion portion 72A that is an opening portion, when the print head 2 is not set in the print head insertion portion 72A. The lid member 83 is assembled to the lid block 72 via a lid hinge 82. The lid member 83 forms a lid member protrusion portion 83A in order to reduce frictional resistance when the print head 2 is inserted into the head cleaning unit 4.

Then, the cleaning nozzle 74 that sprays the solvent 69A for head cleaning toward the print head 2, and the air nozzle 75 that blows air for drying the print head 2 that is wet with the solvent 69A after head cleaning are assembled to the lid block 72 by press-fitting.

The cleaning nozzle 74 forms a liquid flow path portion 74A that is formed inside the cleaning nozzle 74 so as to extend in a direction from the nozzle 21 to the gutter 25 when the print head 2 is set in the head cleaning unit 4; a liquid discharge hole A portion 74B that is connected to the liquid flow path portion 74A to spray the solvent 69A toward the nozzle 21; a liquid discharge hole B portion 74C that is connected to the liquid flow path portion 74A to spray the solvent 69A toward the deflection electrode 24; and a liquid discharge hole C portion 74D that is connected to the liquid flow path portion 74A to spray the solvent 69A toward a surface of the protective cover 17 in which the printing opening portion 17A is formed. Then, the liquid flow path portion 74A formed in the cleaning nozzle 74 is connected to a liquid flow path portion 72B formed in the lid block 72.

The air nozzle 75 forms an air flow path portion 75A that is formed inside the air nozzle 75 so as to extend in the direction from the nozzle 21 to the gutter 25 when the print head 2 is set in the head cleaning unit 4; an air discharge hole A portion 75B that is connected to the air flow path portion 75A to spray air toward a gap between the nozzle 21 and the charging electrode 23; and an air discharge hole B portion 75C that is connected to the air flow path portion 75A to spray air toward the protective cover 17. Then, the air flow path portion 75A formed in the air nozzle 75 is connected to an air flow path formed in the lid block 72.

Then, the head cleaning unit 4 includes the cleaning tank 71 that contains the print head 2 during head cleaning, below the lid block 72. The cleaning tank 71 forms a side wall portion 71A which is formed such that the solvent 69A sprayed from the cleaning nozzle 74 is prevented from scattering around, and a liquid outlet portion 71D through which the solvent 69A discharged from the cleaning nozzle 74 flows to a lower side of the cleaning tank 71. Then, the cleaning tank 71 includes a conical inner bottom portion 71C which is formed in an inclined shape such that the liquid outlet portion 71D is located at a lowest position to facilitate collection of the solvent 69A in the liquid outlet portion 71D. A temperature sensor B 84 that detects and uses ambient temperature of the head cleaning unit 4 for various controls is assembled into the cleaning tank 71.

Further, the head cleaning unit 4 includes the recovery container 73 that contains the solvent 69A which is used during head cleaning, at the lower portion of the cleaning tank 71. The recovery container 73 contains the solvent 69A that is used during head cleaning to drip down from the liquid outlet portion 71D of the cleaning tank 71, as the recovery solvent 69B. The recovery container 73 includes a liquid storage portion 73A that retains the recovery solvent 69B, and the liquid storage portion 73A is sealed by combining an upper portion of the recovery container 73 and the lower portion of the cleaning tank 71. In addition, the recovery container 73 includes the liquid amount sensor 76 that detects when a liquid level 69C of the recovery solvent 69B drops to a certain value or less and when the liquid level 69C rises to the certain value or more.

In the recovery container 73, the filter 77 (for the recovery container) is assembled to a lower portion of the liquid storage portion 73A to remove foreign matter that is mixed into the recovery solvent 69B during head cleaning or the like. A liquid reservoir portion 73B that contains the recovery solvent 69B which is filtered is formed at a lower portion of the filter 77 (for the recovery container). A solvent reuse flow path 73C connected to the liquid reservoir portion 73B is formed in the recovery container 73, and the solvent reuse flow path 73C is connected to a tube 823A via a reuse joint 80. The tube 823A forms a part of the solvent reuse paths 823, 824 and 807, and the recovery solvent 69B is replenished to the ink container 31 via the tube 823A.

In addition, a liquid discharge flow path 73D connected to the liquid reservoir portion 73B is formed in the recovery container 73, and the liquid discharge flow path 73D is connected to a tube 86 made of a solvent resistant fluorine material, via a discharge joint A 81. A discharge joint B 87 is assembled to the tube 86 by press-fitting an end portion of the discharge joint B 87 to an outlet portion of the tube 86 opposite the discharge joint A 81. A tube fixing portion 71G is formed in the cleaning tank 71, and the discharge joint B 87 is fixed to the tube fixing portion 71G by a nut 89. A seal member 88 is assembled to the tube fixing portion 71G. The seal member 88 seals a gap between the discharge joint B 87 and the cleaning tank 71 to prevent the solvent 69A from flowing to the outside of the cleaning tank 71 and the recovery container 73.

In addition, a communication hole portion 71F is formed at a center of the tube fixing portion 71G of the cleaning tank 71, and when the discharge joint B 87 is fixed to the cleaning tank 71, the internal space of the cleaning tank 71 and an internal space of the tube 86 have the same pressure. For this reason, an internal space of the recovery container 73 communicating with the cleaning tank 71 and the liquid outlet portion 71D, and the internal space of the tube 86 have the same pressure. For this reason, the liquid level 69C of the recovery solvent 69B and a liquid level 69D of the tube 86 are the same liquid level. Accordingly, for example, even when the recovery container 73 is not transparent, the liquid amount of the recovery container 73 can be confirmed by confirming the liquid level of the tube 86.

In addition, a liquid joint 78 connected to the liquid flow path portion 72B is assembled to the lid block 72, and a tube 822A is connected to the liquid joint 78 by a method such as press-fitting. The tube 822A forms a part of the head cleaning paths 809, 821 and 822, and the lid block 72 is connected to the solvent container 33 via the tube 822A. Furthermore, an air joint 79 connected to an air flow path portion 72C is assembled to the lid block 72, and a tube 825A is connected to the air joint 79 by a method such as press-fitting. The tube 825A forms a part of the path (for dry air) 825, and the lid block 72 is connected to the pump 38 (for dry air supply) via the tube 825A.

Then, the head cleaning unit 4 is covered with a cover 85 not to expose the tube 822A, the tube 823A, and the tube 825A to the outside of the head cleaning unit 4, and the cover 85 is fixed to interpose an upper portion of the lid block 72 and a lower portion of the recovery container 73. The conduit 6 (for the head cleaning unit) is assembled to a lower portion of the cover 85 to protrude outward but not to interfere with other production equipment.

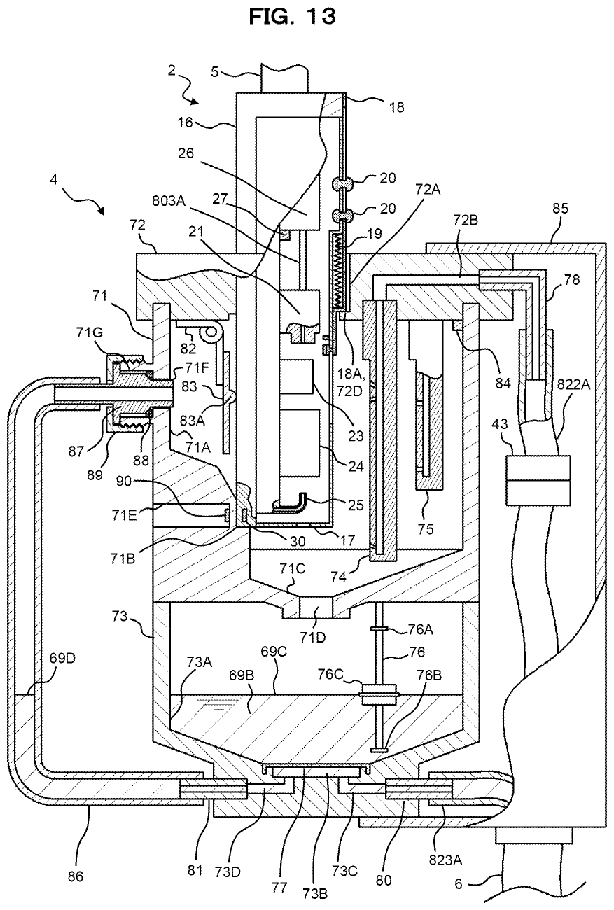

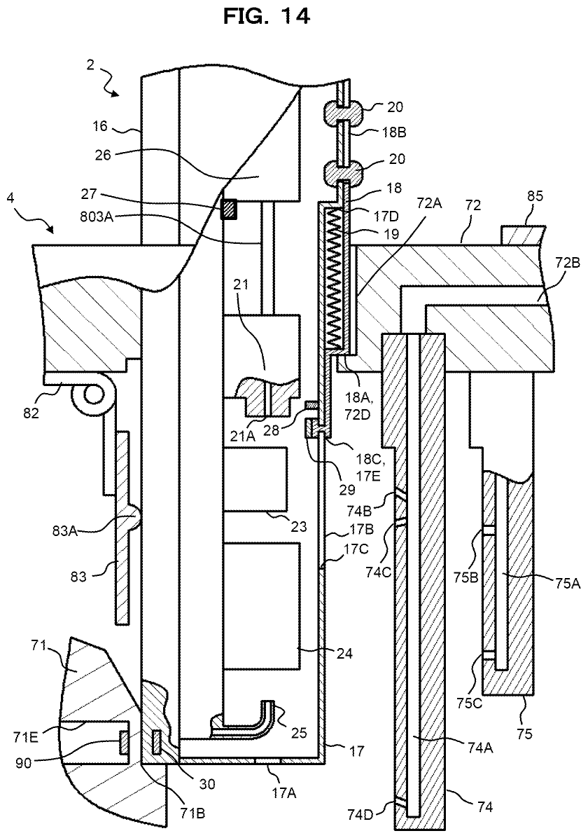

Next, a configuration of a state where the print head 2 is set in the head cleaning unit 4 of the inkjet recording device 600 according to the first embodiment will be described with reference to FIGS. 13 and 14. FIG. 13 is a partial cross-sectional view of the head cleaning unit 4 illustrating a state where the print head 2 is set in the head cleaning unit 4 of the first embodiment. FIG. 14 is an enlarged view illustrating a configuration of the print head 2, the cleaning nozzle 74 and of the vicinity thereof in FIG. 13.

In FIGS. 12 to 14, the print head 2 is set in the head cleaning unit 4. The print head 2 is inserted into the print head insertion portion 72A, so that the lid member 83 of the head cleaning unit 4 is opened. The print head 2 is pushed to a position where the nozzle 21, the charging electrode 23, the deflection electrode 24, and the gutter 25 get into the cleaning tank 71. Then, an inner wall surface of a hole of the print head insertion portion 72A and an outer wall surface of the print head 2 are fitted to each other so as to prevent misalignment from being misaligned from the print head 2, thereby making it difficult for the head cleaning unit 4 to be shifted in every direction. Furthermore, the head base 16 of the print head 2 stands still at a position where the head base 16 abuts against a print head support portion 71B formed in the cleaning tank 71, so that the position of the print head 2 when being set in the head base 16 is stable.

A sensor attachment portion 71E is formed in the cleaning tank 71, and a proximity sensor B 90 is attached to the sensor attachment portion 71E. Then, a magnet B 30 is assembled to the head base 16 of the print head 2, and when a distance between the magnet B 30 and the proximity sensor B 90 is a certain distance or less, the magnet B 30 can be detected by the proximity sensor B 90. Since the magnet B 30 and the proximity sensor B 90 are close to each other within the certain distance or less in a state where the print head 2 is set in the head cleaning unit 4, the proximity sensor B 90 detects the magnet B 30, and it can be determined that the print head 2 is set in the head cleaning unit 4.

In addition, in a state where the print head 2 is set in the head cleaning unit 4, the opening and closing support portion 18A of the protective cover door 18 hits a door support portion 72D formed in the lid block 72. In the print head 2, since the weight of the print head 2 is larger than the spring force of the door closing spring 19, the door closing spring 19 is compressed. The print head 2 moves in a down direction until the print head 2 abuts against the print head support portion 71B, but the position of the protective cover door 18 is not moved below the door support portion 72D, so that the cleaning opening portion 17B covered with the protective cover door 18 is opened. Then, since the distance between the proximity sensor A 28 assembled to the protective cover 17 and the magnet A 29 assembled to the protective cover door 18 is detected as being the certain distance or less, it can be determined that the print head 2 is set in the head cleaning unit 4.

### <Method for Using Head Cleaning Unit>

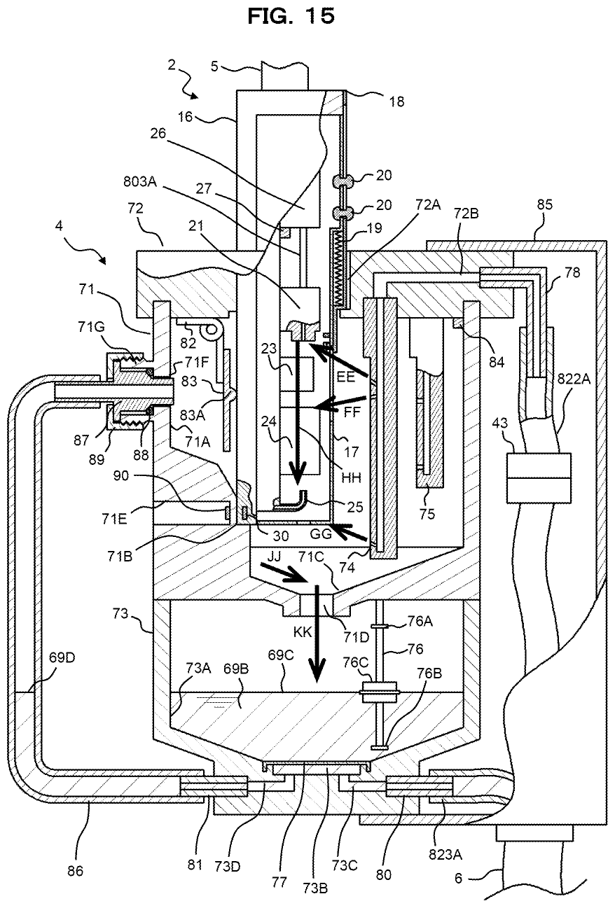

Next, an operation when the head cleaning process is carried out in a state where the print head 2 is set in the head cleaning unit 4 in the inkjet recording device 600 according to the first embodiment will be described with reference to FIG. 15. FIG. 15 is a cross-sectional view of the head cleaning unit 4 illustrating flows of liquid inside the head cleaning unit 4 when the head cleaning process is performed in the first embodiment.

In FIG. 15, the inkjet recording device 600 sprays the solvent 69A from the cleaning nozzle 74 to clean the print head 2 in the head cleaning process. The solvent 69A supplied to the cleaning nozzle 74 is sprayed as the solvent 69A in a direction indicated by an arrow EE (direction where the solvent 69A is sprayed from the liquid discharge hole A portion 74B toward the nozzle 21) and in a direction indicated by an arrow FF (direction where the solvent 69A is sprayed from the liquid discharge hole B portion 74C toward the deflection electrode 24), the solvent 69A enters the inside of the protective cover 17 from the cleaning opening portion 17B, and the solvent 69A is blown onto the components such as the nozzle 21 and the deflection electrode 24 assembled to the print head 2, so that dirt caused by the ink 68A that has adhered during operation or maintenance of the inkjet recording device 600 can be cleaned.

The solvent 69A that is blown onto the components such as the nozzle 21 and the deflection electrode 24 assembled to the print head 2 drips and flows in a direction indicated by an arrow HH because of gravity, and the gutter 25 disposed below the charging electrode 23 and the deflection electrode 24 in a state where the print head 2 is set in the head cleaning unit 4 can be cleaned with the solvent 69A. In addition, the solvent 69A supplied to the cleaning nozzle 74 is sprayed as the solvent 69A in a direction indicated by an arrow GG (direction where the solvent 69A is sprayed from the liquid discharge hole C portion 74D toward the surface of the protective cover 17 in which the printing opening portion 17A is formed), and the solvent 69A is blown onto the protective cover 17, so that dirt caused by the ink 68A that has adhered to an outer side of the print head 2 can be cleaned.

Then, in the head cleaning process, the solvent 69A that has cleaned the components such as the nozzle 21, the charging electrode 23, the deflection electrode 24, the gutter 25, and the protective cover 17 disposed in the print head 2 drips down in directions indicated by arrows JJ and KK, flows into the recovery container 73 disposed at a lower portion of the head cleaning unit 4, and is stored in the liquid storage portion 73A as the recovery solvent 69B.

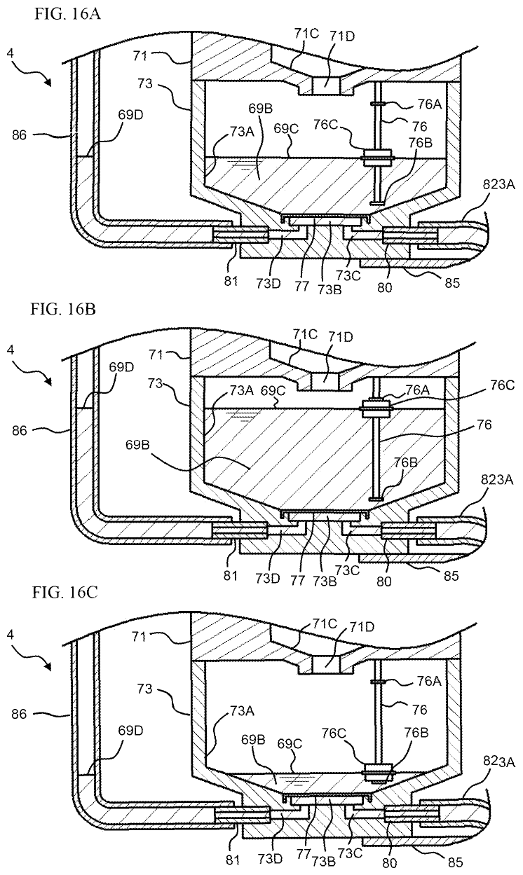

Next, the detection of a liquid level of the recovery container 73 in each state of the inkjet recording device 600 according to the first embodiment will be described with reference to FIG. 16. FIG. 16 is a cross-sectional view mainly illustrating the recovery container 73 of the head cleaning unit 4 in the present embodiment. FIG. 16(a) illustrates a state where the liquid amount sensor 76 of the recovery container 73 does not detect both of the maximum liquid amount detection portion 76A and the minimum liquid amount detection portion 76B. FIG. 16(b) illustrates a state where the liquid amount sensor 76 detects the maximum liquid amount detection portion 76A since the liquid amount of the recovery solvent 69B in the recovery container 73 is large. Then, FIG. 16(c) illustrates a state where the liquid amount sensor 76 detects the minimum liquid amount detection portion 76B since the liquid amount of the recovery solvent 69B in the recovery container 73 is small.

In FIG. 16(a), the liquid amount sensor 76 installed inside the recovery container 73 includes a float portion 76C that is displaced together with the liquid level 69C of the recovery solvent 69B; the maximum liquid amount detection portion 76A that is installed below the liquid outlet portion 71D of the cleaning tank 71 and that is detected when the float portion 76C approaches the maximum liquid amount detection portion 76A; and the minimum liquid amount detection portion 76B that is installed below the maximum liquid amount detection portion 76A and above the filter 77 (for the recovery container) and that is detected when the float portion 76C approaches the minimum liquid amount detection portion 76B. The float portion 76C does not detect both of the maximum liquid amount detection portion 76A and the minimum liquid amount detection portion 76B. In this state, the recovery solvent 69B contained in the recovery container 73 can be normally replenished to the ink container 31. In addition, in the inkjet recording device 600, the head cleaning process can be carried out by setting the print head 2 in the head cleaning unit 4 and by spraying the solvent 69A from the cleaning nozzle 74.

Next, in FIG. 11(b), a state where the liquid amount sensor 76 detects the maximum liquid amount detection portion 76A since the liquid amount of the recovery solvent 69B in the recovery container 73 is large will be described. In the recovery container 73, since the head cleaning process is repeatedly performed, the amount of the recovery solvent 69B is increased and the liquid level C is high. Since the float portion 76C that is displaced in conjunction with the liquid level 69C and the maximum liquid amount detection portion 76A are close to each other within a certain distance or less, the liquid amount sensor 76 is capable of determining that the liquid amount of the recovery solvent 69B is large. When this state is detected, in order to prevent the recovery solvent 69B from overflowing from the recovery container 73, the inkjet recording device 600 performs control not to spray the solvent 69A from the cleaning nozzle 74.

Next, in FIG. 11(c), a state where the liquid amount sensor 76 detects the minimum liquid amount detection portion 76B since the liquid amount of the recovery solvent 69B in the recovery container 73 is small will be described. In the recovery container 73, since the head cleaning process is not carried out for a certain time, the amount of the recovery solvent 69B is decreased and the liquid level 69C is low. Since the float portion 76C that is displaced in conjunction with the liquid level and the minimum liquid amount detection portion 76B are close to each other within a certain distance or less, the liquid amount sensor 76 is capable of determining that the liquid amount of the recovery solvent 69B is small. When this state is detected, since the recovery solvent 69B contained in the recovery container 73 cannot be normally replenished to the ink container 31, the inkjet recording device 600 performs control to replenish the ink container 31 with the solvent 69A from the solvent container 33 and to adjust the solvent concentration of the ink 68A.

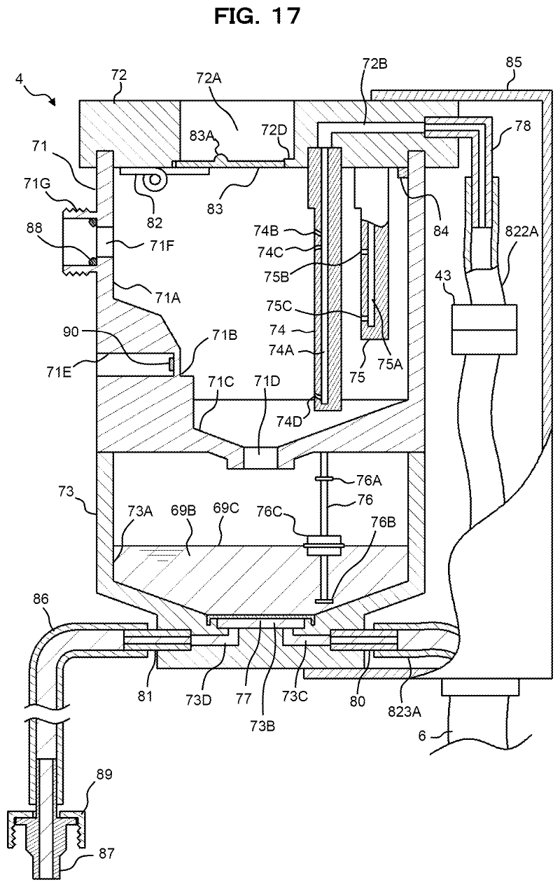

Next, work of extracting the liquid of the recovery container 73 of the inkjet recording device 600 according to the first embodiment will be described with reference to FIG. 17. FIG. 17 is a cross-sectional view of the head cleaning unit 4 when work of extracting the liquid of the recovery container 73 is performed. In the inkjet recording device 600, when the recovery solvent 69B of the recovery container 73 is large and the liquid amount sensor 76 detects the maximum liquid amount detection portion 76A, the head cleaning process cannot be carried out. In that case, when the head cleaning process is carried out, the liquid amount of the recovery solvent 69B in the recovery container 73 needs to be reduced so as not to detect the maximum liquid amount detection portion 76A. One of the methods is to replenish the ink container 31 with the recovery solvent 69B of the recovery container 73, but it may take time for the liquid amount of the recovery solvent 69B to be reduced. Another method is to extract the recovery solvent 69B from the recovery container 73.

In FIG. 17, the discharge joint B 87 is removed from the tube fixing portion 71G of the cleaning tank 71, and the tube 86 is disposed such that the discharge joint B 87 is located below the recovery container 73. Accordingly, the recovery solvent 69B contained in the recovery container 73 is capable of flowing out to the outside of the head cleaning unit 4.

### Effects of First Embodiment

As described above, according to the first embodiment of the present invention, cleaning can be easily performed merely by setting (inserting) the print head in the head cleaning unit and further, the solvent 69A used for head cleaning can be collected and contained in the recovery container 73. In addition, the recovery solvent 69B can be reused to adjust the concentration of the ink 68A stored in the ink container 31.

For this reason, according to the inkjet recording device 600, the labor required to dispose of the recovery solvent 69B during head cleaning work can be reduced, and the disposal amount of the recovery solvent 69B can be reduced, so that the inkjet recording device 600 capable of reducing the running cost imposed on a customer can be provided.

### Second Embodiment

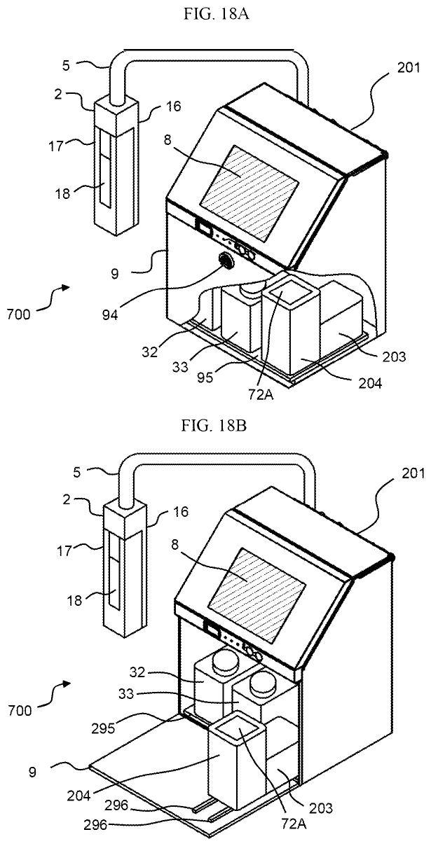

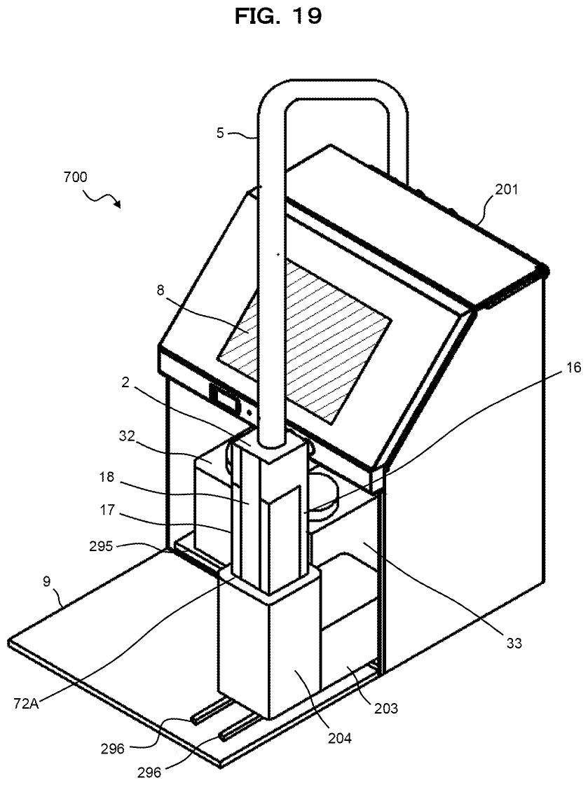

An inkjet recording device 700 in a second embodiment of the present invention will be described with reference to FIGS. 18 and 19. Incidentally, a description of portions that are common to the first embodiment described above will be omitted, and portions that are different from those in the first embodiment will be mainly described.

### <Exterior Configuration>

FIG. 18 is an exterior perspective view illustrating the inkjet recording device 700 in the present embodiment, and the main body 1 is partially cut out such that the inside thereof can be seen. FIG. 19 is a perspective view illustrating a state where the print head 2 is attached to a cleaning tank 271 in the inkjet recording device 700 in the present embodiment.

First, as illustrated in FIG. 18(a), the inkjet recording device 700 includes a main body 201, and the print head 2 that is connected to the main body 1 by the conduit 5 (for the print head). The main body 201 includes a maintenance door 9 on a front surface, and a container base 95 assembled to a lower portion of the main body 201, and the auxiliary ink container 32, the solvent container 33, and circulation components such as a head cleaning unit 204 and a drive unit 203 on the container base 95 are assembled inside the maintenance door 9. A maintenance door handle 94 is assembled to an upper center portion of the maintenance door 9, and allows a worker to easily open and close the maintenance door 9. In the inkjet recording device 700, the maintenance door 9 can be opened to replenish the auxiliary ink container 32 with the ink 68A, to replenish the solvent container 33 with the solvent 39A, to clean the print head 2 with the solvent 69A using the head cleaning unit 204, or to perform daily maintenance work.

In the inkjet recording device 700 illustrated in FIG. 18(b), the maintenance door 9 is opened, and the head cleaning unit 204 is pulled out to the front. The maintenance door 9 can be opened up to an angle of 90°, and a rail 296 is formed on a back surface of the maintenance door 9. The head cleaning unit 204 can be pulled out to a front side on the rail 296. The head cleaning unit 204 is integrated with the drive unit 203 for the purpose of simplifying components.

Next, a state where the print head 2 is set in the head cleaning unit 204 in the inkjet recording device 700 will be described with reference to FIG. 19. The print head 2 is inserted into the print head insertion portion 72A of the head cleaning unit 204 from the tip of the print head 2. In the inkjet recording device 700 according to the present embodiment, the print head 2 can be cleaned by setting the print head 2 in the head cleaning unit 204 in such a manner.

### <Path Configuration>

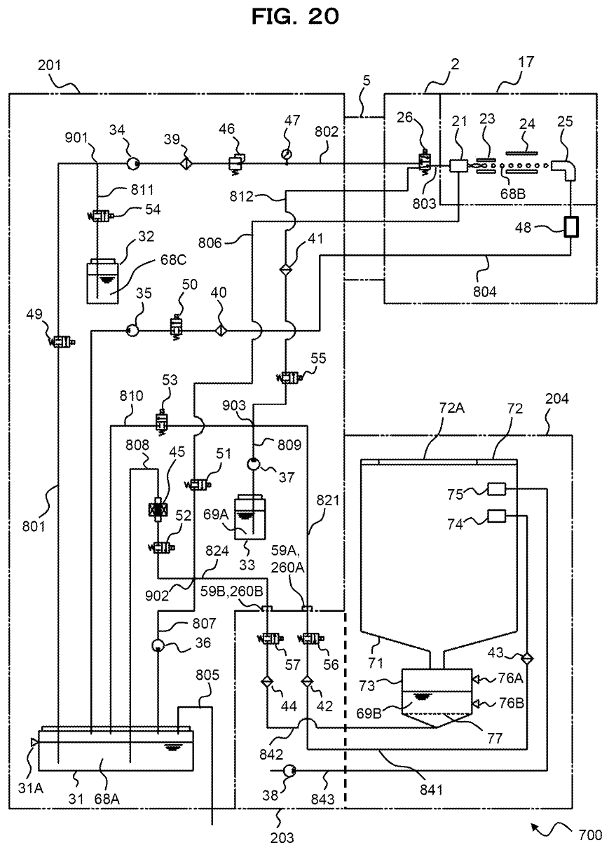

FIG. 20 diagram illustrating an overall path configuration of the inkjet recording device 700 in the present embodiment. Incidentally, a description of portions that are common to the first embodiment will be omitted, and portions that are different from those in the first embodiment will be mainly described.

The head cleaning paths 809, 821 and 841 of the inkjet recording device 700 in the present embodiment will be described. In FIG. 20, the pump 37 (for the solvent) is connected to the path 821 via the branch path 903, and the path 821 is connected to the path 841 via the connecting portion 59A (for head cleaning) and a joint 260A (for head cleaning) for relaying to the drive unit 203 assembled into the main body 201. The electromagnetic valve 55 (for nozzle cleaning) that opens and closes a flow path is disposed in the path 841, and the electromagnetic valve 55 (for nozzle cleaning) is connected to the filter 42 (for head cleaning) that removes foreign matter mixed in the solvent 69A.

The filter 42 (for head cleaning) is connected to the filter 43 (for nozzle cleaning) that removes foreign matter which has initially entered the path 841. Then, the filter 43 (for nozzle cleaning) is connected to the cleaning nozzle 74 provided inside the cleaning tank 71 of the head cleaning unit 204. Here, the internal space of the cleaning tank 71 is configured to communicate with the recovery container 73 installed at the lower portion of the cleaning tank 71.

Next, the solvent reuse paths 842, 824 and 807 of the inkjet recording device 700 in the present embodiment will be described. In FIG. 20, the head cleaning unit 204 includes the recovery container 73 that retains the recovery solvent 69B which is used for head cleaning and then flows thereinto because of its own weight, and the filter 77 (for the recovery container) is assembled to the recovery container 73 such that foreign matter which is mixed during head cleaning is prevented from flowing into the path 842. The recovery container 73 is connected to the path 842 at a portion that is immersed in the recovery solvent 69B, and the filter 44 (for solvent reuse) that prevents fine foreign matter contained in the recovery solvent 69B, from being mixed into the ink 68A is disposed in the path 842 at the drive unit 203 inside the main body 201.

The electromagnetic valve 57 (for solvent reuse) that opens and closes a flow path is connected to the filter 44 (for solvent reuse), and the path 842 in which the electromagnetic valve 57 (for solvent reuse) is disposed is connected to the path 824 via the connecting portion 59B (for solvent reuse) and a joint 260B (for solvent reuse) for relaying to the drive unit 203. The path 824 is configured to be connected to the pump 36 (for circulation) disposed in the path 807, via the merging path 902. Accordingly, the recovery solvent 69B retained in the recovery container 73 can be replenished to the ink container 31, and can be reused to adjust the concentration of the ink.

Next, a head drying air path 843 of the inkjet recording device 700 in the present embodiment will be described. In FIG. 20, the drive unit 203 stored inside the main body 201 is provided with the pump 38 (for dry air supply) that is used to suction and pressure-feed air, and the pump 38 (for dry air supply) forms an air suction port communicating with the inside of the main body 201. The pump 38 (for dry air supply) is connected to the air nozzle 75 provided inside the cleaning tank 71 of the head cleaning unit 204.

### Effects of Second Embodiment

As described above, according to the second embodiment of the present invention, in the inkjet recording device 700, the cleaning tank 271 and the recovery container 273 are disposed inside the main body 201, thereby being capable of providing the inkjet recording device 700 having a head cleaning function and a function of reusing the recovery solvent 69B similarly to the first embodiment and having improved installability.

### Other Embodiments

The first and second embodiments have been described above; however, the present invention is not limited to the above-described first embodiment, and includes various modification examples. In addition, the above-described first and second embodiments have been described in detail for easy understanding of the present invention, and the present invention is not necessarily limited to including all the described configurations.

### REFERENCE SIGNS LIST

1 Main body
2 Print head
3 Drive unit
4 Heat cleaning unit
5 Conduit
6 Conduit
8 Operation display portion
9 Maintenance door
10 Control unit
11 Belt conveyor
12A Object to be printed (before printing)
12B Object to be printed (after printing)
13 Print head fixing fitting
14 Conveyor column
16 Head base
17 Protective cover
17A Printing opening portion
17B Cleaning opening portion
17C Opening lower end portion
17D Seat surface portion
17E Opening upper end portion
18 Protective cover door
18A Opening and closing support portion
18B Slot portion
18C Door lower end portion
18D Door upper end portion
19 Door closing spring
20 Pin
21 Nozzle
21A Discharge port
23 Charging electrode
24 Deflection electrode
25 Gutter
25A Gutter discharge port
26 Switching valve
27 Temperature sensor A
28 Proximity sensor A
29 Magnet A
30 Magnet B
31 Ink container
31A Liquid level sensor
32 Auxiliary ink container
33 Solvent container
34 Pump (for supply)
35 Pump (for recovery)
36 Pump (for circulation)
37 Pump (for solvent)
38 Pump (for dry air supply)
39 Filter (for supply)
40 Filter (for recovery)
41 Filter (for nozzle cleaning)
42 Filter (for head cleaning)
43 Filter (for cleaning nozzle)
44 Filter (for solvent reuse)
45 Viscometer
46 Pressure regulating valve
47 Pressure sensor
48 Charge sensor (detection means)
49 Electromagnetic valve (for supply)
50 Electromagnetic valve (for recovery)
51 Electromagnetic valve (for circulation)
52 Electromagnetic valve (for viscosity measurement)
53 Electromagnetic valve (for solvent replenishment)
54 Electromagnetic valve (for ink replenishment)
55 Electromagnetic valve (for nozzle cleaning)
56 Electromagnetic valve (for head cleaning)
57 Electromagnetic valve (for solvent reuse)
58 Storage area
59A Connecting portion (for head cleaning)
59B Connecting portion (for solvent reuse)
60A Joint (for head cleaning)
60B Joint (for solvent reuse)
61A Seal plug (for solvent supply)
61B Seal plug (for solvent reuse)
63 Start button
64 Stop button
65 Display portion
68A Ink
68B Ink particle
69A Solvent
69B Recovery solvent
69C Liquid level
69D Liquid level
71 Cleaning tank
71A Side wall portion
71B Print head support portion
71C Conical inner bottom portion
71D Liquid outlet portion
71E Sensor attachment portion
71F Communication hole portion
71G Tube fixing portion
72 Lid block
72A Print head insertion portion
72B Liquid flow path portion
72C Air flow path portion
72D Door support portion
73 Recovery container
73A Liquid storage portion
73B Liquid reservoir portion
73C Solvent reuse flow path
73D Liquid discharge flow path
74 Cleaning nozzle
74A Liquid flow path portion
74B Liquid discharge hole A portion
74C Liquid discharge hole B portion
74D Liquid discharge hole C portion
75 Air nozzle
75A Air flow path portion
75B Air discharge hole A portion
75C Air discharge hole B portion
76 Liquid amount sensor
76A Maximum liquid amount detection portion
76B Minimum liquid amount detection portion
76C Float portion
77 Filter (for recovery container)
78 Liquid joint
79 Air joint
80 Reuse joint
81 Discharge joint A
82 Lid hinge
83 Lid member
83A Lid member protrusion portion
84 Temperature sensor B
85 Cover
86 Tube
87 Discharge joint B
88 Seal member
89 Nut
90 Proximity sensor B
91 Fixing jig (for main body)
92 Fixing jig (for conveyor)
93 Fixing jig fitting portion
94 Maintenance door handle
201 Main body
203 Drive unit
204 Head cleaning unit
260A Joint (for head cleaning)
260B Joint (for solvent reuse)
271 Cleaning tank
273 Recovery container
295 Container base
296 Rail
600 Inkjet recording device
700 Inkjet recording device
801 to 803 Path (for supply)
804 Path (for recovery)
805 Path (for exhaust)
806, 807 Path (for circulation)
808 Path (for viscosity measurement)
809 Path (for solvent supply)
810 Path (for solvent replenishment)
811 Path (for ink replenishment)
812 Path (for nozzle cleaning)
821, 822 Path (for head cleaning)
823, 824 Path (for solvent reuse)
825 Path (for dry air)
841 Path (for head cleaning)
842 Path (for solvent reuse)
843 Path (for dry air)
901 Merging path (for supply)
902 Merging path (for circulation)
903 Branch path (for solvent)

1. A method for controlling an inkjet recording device comprising:
providing a print head that receives a supply of ink to perform printing;
providing a main body that includes an ink container to contain the ink and a solvent container to contain a solvent, and that supplies the ink in the ink container to the print head; wherein
the print head includes a nozzle that discharges the ink as ink particles, a charging electrode that charges the ink particles discharged from the nozzle a deflection electrode that changes a flight direction of the charged ink particles, and a gutter that recovers the ink particles making no contribution to the printing,
the inkjet recording device comprises a head cleaning unit in which the print head is set to clean the print head;
providing a recovery container at the bottom portion of the head cleaning unit;
detecting, using a sensor, whether or not the print head is set in the head cleaning unit; and
controlling, using a control unit, the supply of ink;
controlling, when the print head is set in the head cleaning unit, the supply of the ink to the nozzle and the recovery of the discharged ink from the gutter, wherein the gutter is located between the nozzle and recovery container;
providing a plurality of ink circulation paths; and
connecting, a pump to the circulation paths; and
circulating, using the pump, the ink in a state where the print head is set in the head cleaning unit.

2. The method according to claim 1, further comprising:
detecting, using a detector, whether or not the ink discharged from the nozzle is recovered from the gutter,
wherein when the detector detects that the ink is not recovered from the gutter, discharge of the ink from the nozzle is stopped.

3. The method according to claim 1, further comprising:
detecting, using a charge sensor, a charge amount of the ink particles charged by the charging electrode, wherein in a state where the print head is mounted in the head mounting portion, the ink particles are discharged from the nozzle, the ink particles discharged from the nozzle are charged by the charging electrode, and the charge amount of the ink particles is detected by the charge sensor.

4. The method according to claim 3, further comprising:
determining whether or not the ink particles discharged from the nozzle are recovered from the gutter, based on a detection result of the charge sensor, and when it is determined that the ink particles are not recovered from the gutter, discharge of the ink from the nozzle is stopped.

5. The method according to 1, further comprising:
repeating the circulation of the ink.

6. The method according to claim 1, further comprising:
providing a viscometer that detects a viscosity of the ink, wherein control is performed such that the viscosity of the ink is regularly measured and the viscosity of the ink is within a certain range.

7. The method according to claim 1, further comprising:
supplying the solvent, in a cleaning mode, to clean the print head in a state where the print head is set in the head cleaning unit.

8. The method according to claim 1, wherein
the head cleaning unit includes an air nozzle that supplies air, and
the main body includes an air supply unit that supplies the air to the air nozzle.

9. The method according to claim 8, wherein
wherein when the print head is cleaned with the solvent, the nozzle that discharges the ink or the gutter carries out an operation of suctioning a cleaning liquid or the air.

10. The method according to claim 9, further comprising:
providing the print head or the head mounting portion with a temperature detector, and an air spray time is controlled using the air supply unit based on a detection value of the temperature detector.
